(19) United States
(12) Patent Application Publication
(10) Pub. No.: US 2005/0044963 A1
(43) Pub. Date: Mar. 3, 2005

(54) High-resolution gas gauge proximity sensor

(75) Inventor: Joseph H. Lyons, Wilton, CT (US)

Correspondence Address: STERNE, KESSLER, GOLDSTEIN & FOX PLLC, 1100 NEW YORK AVENUE, N.W., WASHINGTON, DC, 20005, US

(73) Assignee: ASML Holding N.V.

(21) Appl. No.: 10/646,720

(22) Filed: Aug. 25, 2003

(51) Int. Cl. G01F 1/00

(52) U.S. Cl. 73/861

(57) ABSTRACT

A system and method for precisely detecting very small distances between a measurement probe having an elongated nozzle with a relatively long and thin orifice. The proximity sensor uses a constant gas flow and senses a mass flow rate within a pneumatic bridge to detect very small distances. The system and method use a flow restrictor and/or snubber made of porous material and/or a mass flow rate controller that in various combinations allow for detection of very small distances in the nanometer to sub-nanometer range.

### BACKGROUND OF THE INVENTION

1. Field of the Invention

The present invention relates to an apparatus and method for detecting very small distances, and more particularly to proximity sensing with gas flow.

2. Related Art

Many automated manufacturing processes require the sensing of the distance between a manufacturing tool and the product or material surface being worked, often referred to as the “workpiece” In some situations, such as semiconductor photolithography, the distance must be measured with accuracy approaching a nanometer

The challenges associated with creating a proximity sensor of such accuracy are significant, particularly in the context of photolithography systems. In the photolithography context, in addition to being non-intrusive and having the ability to precisely detect very small distances, the proximity sensor can not introduce contaminants or come in contact with the work surface, typically a semiconductor wafer, flat panel display, or the like. Occurrence of either situation may significantly degrade or ruin the workpiece.

Different types of proximity sensors are available to measure very small distances. Examples of proximity sensors include capacitance and optical gauges. These proximity sensors have serious shortcomings when used in photolithography systems because physical properties of materials deposited on wafers may impact the precision of these devices. For example, capacitance gauges, being dependent on the concentration of electric charges, can yield spurious proximity readings in locations where one type of material (e.g., metal) is concentrated. Another class of problems occurs when exotic wafers made of non-conductive and/or photosensitive materials, such as Gallium Arsenide (GaAs) and Indium Phosphide (InP), are used. In these cases, capacitance and optical gauges are not optimal.

U.S. Ser. No. 10/322,768 and U.S. Pat. Nos. 4,953,388 and 4,550,592, which are all incorporated herein by reference in their entireties, disclose an alternative approach to proximity sensing that uses an air gauge sensor. An air gauge sensor is not vulnerable to concentrations of electric charges or electrical, optical, and other physical properties of a substrate surface. Current semiconductor manufacturing, however, requires that proximity be gauged with high precision on the order of nanometers.

FIG. 6 shows an end view and characteristics of a circular gas gauge proximity sensor 600. One issue with proximity sensor 600 is that the sensitivity footprint, depending on the nozzle size and standoff, is often a torus like shape. Based on the torus shape, sensor 600 can have a region 602 of lesser sensitivity (see area 606 on graph 608) right under the orifice 604. This can be because side restriction regions 603 have a separation S. Sensed area 603 can be a “scanned” footprint based on several successive readings. Ideally, it is desirable to eliminate this lower sensitivity region 602 in the central portion of air gauge 600.

One way to achieve this is to provide a dramatically smaller orifice, but this can result in a smaller sensing area and less standoff. Additionally, when used as a scanning device, the topography passing near the center of the device is not considered as important as the topography passing near the upper or lower shell. Additionally, it is often desirable to compare topography results between sensor types (optical, capacitate etc). The unusual sensitivity footprint of the standard air gauge complicates this process.

Therefore, a more precise gas gauge proximity sensor is needed.

### SUMMARY OF THE INVENTION

Embodiments of the present invention can provide a high-resolution gas gauge proximity sensor and method that significantly improve on the precision of previous types of proximity sensors.

The gas gauge proximity sensor determines proximity based on detecting a difference in measurement and reference standoffs. A standoff is the distance or gap between a nozzle of the proximity sensor and the surface beneath the nozzle. To determine the standoff difference, a flow of gas with a constant mass flow rate is metered with a mass flow controller and is forced through two channels—a measurement channel and a reference channel.

Embodiments of the present invention provide a system and method that direct a gas stream into a reference channel and a measurement channel and evenly restrict gas flow through the reference channel and the measurement channel. Probes can be respectively positioned adjacent ends of the reference channel and the measurement channel. The probes can have an elongated nozzle with a relatively long and thin orifice. A device can be used to sense a mass of gas flow between the reference channel and the measurement channel.

In one aspect of the present invention, a reference surface is positioned a reference standoff from the reference probe. A gas stream from the reference probe impinges on the reference surface after traveling across the reference standoff. A measurement surface is positioned a measurement standoff from the measurement probe. A gas stream from the measurement probe impinges on the measurement surface after traveling across the measurement standoff. The mass flow sensor senses a difference between the reference standoff and the measurement standoff.

Through the above embodiments, a gas gauge proximity sensor can be used that has almost no areas of insensitivity.

Further embodiments, features, and advantages of the present invention, as well as the structure and operation of the various embodiments of the present invention are described in detail below with reference to accompanying drawings.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a diagram of a gas gauge proximity sensor, according to an embodiment of the present invention.

FIG. 2 is a diagram that provides a cross sectional view of a restrictor, according to an embodiment of the present invention.

FIGS. 3-4 show a cross-sectional view and end view, respectively, of a nozzle and its characteristics, according to embodiments of the present invention.

FIG. 5 is a flowchart diagram that shows a method for using a gas gauge proximity sensor to detect very small distances and perform a control action, according to an embodiment of the present invention.

FIG. 6 shows an end view and characteristics of a circular nozzle.

The present invention will now be described with reference to the accompanying drawings. In the drawings, like reference numbers may indicate identical or functionally similar elements. Additionally, the left-most digit(s) of a reference number may identify the drawing in which the reference number first appears.

### DETAILED DESCRIPTION OF THE INVENTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the present invention would be of significant utility.

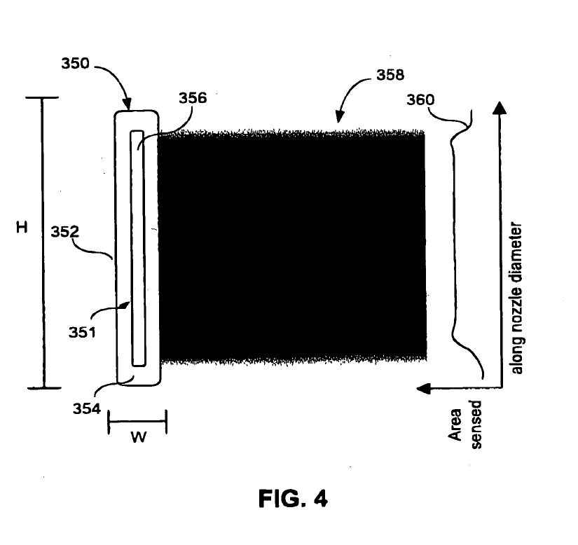

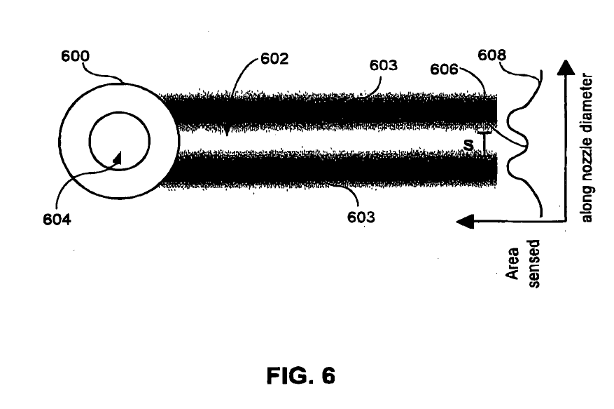

Embodiments of the present invention provide a system and method for precisely detecting very small distances between a measurement probe having an elongated nozzle with a relatively long and thin orifice and a surface, and more particularly to a proximity sensor using a constant gas flow and sensing a mass flow rate within a pneumatic bridge to detect very small distances. Using the elongated nozzle having the long and thin orifice substantially eliminates any low sensitivity areas found in conventional sensors (see FIG. 6, elements 602 and 606) partially because side restriction regions overlap (see FIG. 4, elements 356 and 360).

Gas Gauge Proximity Sensor

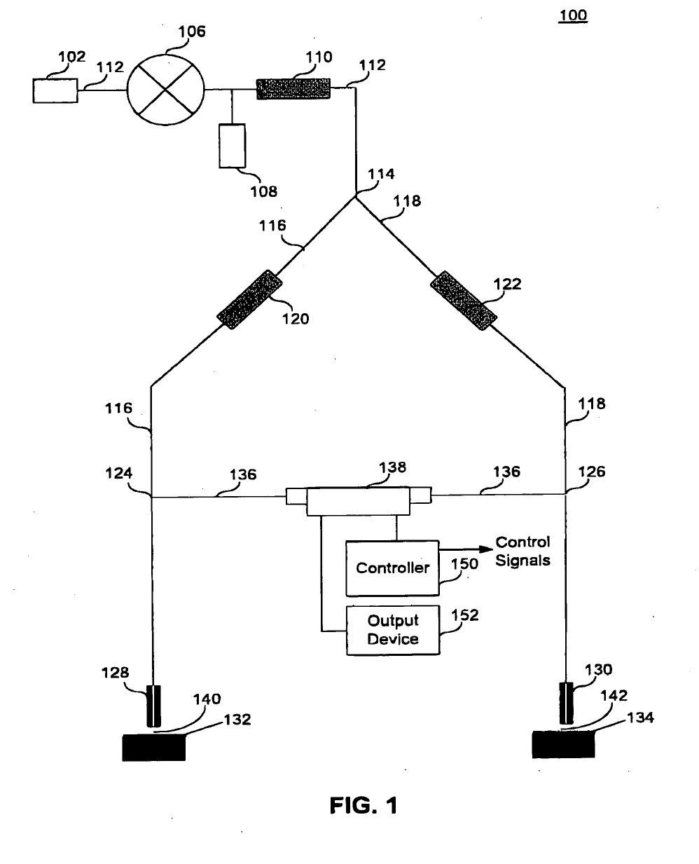

FIG. 1 illustrates a gas gauge proximity sensor 100, according to an embodiment of the present invention. Gas gauge proximity sensor 100 can include a mass flow controller 106, a central channel 112, a measurement channel 116, a reference channel 118, a measurement channel restrictor 120, a reference channel restrictor 122, a measurement probe 128, a reference probe 130, a bridge channel 136, and a mass flow sensor 138. A gas supply 102 can inject gas at a desired pressure into gas gauge proximity sensor 100.

Central channel 112 connects gas supply 102 to mass flow controller 106 and then terminates at a junction 114 (e.g., a gas dividing or directing portion). Mass flow controller 106 can maintain a constant flow rate within gas gauge proximity sensor 100. Gas is forced out from mass flow controller 106 through a porous snubber 110, with an accumulator 108 affixed to channel 112. Snubber 110 can reduce gas turbulence introduced by the gas supply 102, and its use is optional. Upon exiting snubber 110, gas travels through central channel 112 to junction 114. Central channel 112 terminates at junction 114 and divides into measurement channel 116 and reference channel 118. In one embodiment, mass flow controller 106 can inject gas at a sufficiently low rate to provide laminar and incompressible fluid flow throughout the system to minimize the production of undesired pneumatic noise.

A bridge channel 136 is coupled between measurement channel 116 and reference channel 118. Bridge channel 136 connects to measurement channel 116 at junction 124. Bridge channel 136 connects to reference channel 118 at junction 126. In one embodiment, the distance between junction 114 and junction 124 and the distance between junction 114 and junction 126 are equal. It is to be appreciate other embodiments are envisioned with different arrangements.

All channels within gas gauge proximity sensor 100 can permit gas to flow through them. Channels 112, 116, 118, and 136 can be made up of conduits (e.g., tubes, pipes, etc.) or any other type of structure that can contain and guide gas flow through sensor 100, as would be apparent to one of ordinary skill in the art. In most embodiments, channels 112, 116, 118, and 136 should not have sharp bends, irregularities, or unnecessary obstructions that may introduce pneumatic noise, for example, by producing local turbulence or flow instability. In various embodiments, the overall lengths of measurement channel 116 and reference channel 118 can be equal or unequal.

Reference channel 118 terminates adjacent a reference probe 130. Likewise, measurement channel 116 terminates adjacent a measurement probe 128. Reference probe 130 is positioned above a reference surface 134. Measurement probe 128 is positioned above a measurement surface 132. In the context of photolithography, measurement surface 132 can be a semiconductor substrate or stage supporting a substrate. Reference surface 134 can be a flat metal plate, but is not limited to this example.

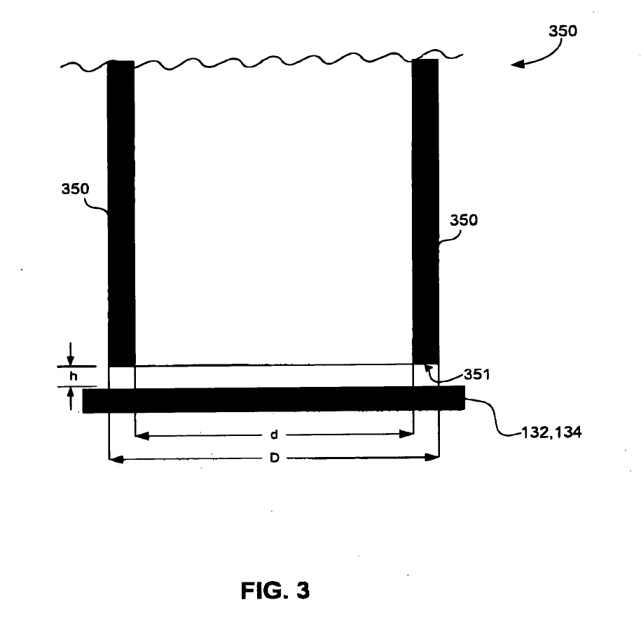

Nozzles are provided in measurement probe 128 and reference probe 130. An example nozzle is described further below with respect to FIGS. 3 and 4. Gas injected by gas supply 102 is emitted from nozzles in probes 128 and 130, and impinges upon measurement surface 132 and reference surface 134.

As described above, the distance between a nozzle and a corresponding measurement or reference surface can be referred to as a standoff.

In one embodiment, reference probe 130 is positioned above a fixed reference surface 134 with a known reference standoff 142. Measurement probe 128 is positioned above measurement surface 132 with an unknown measurement standoff 140. The known reference standoff 142 is set to a desired constant value, which can be at an optimum standoff. With such an arrangement, the backpressure upstream of the measurement probe 128 is a function of the unknown measurement standoff 140; and the backpressure upstream of the reference probe 130 is a function of the known reference standoff 142.

If standoffs 140 and 142 are equal, the configuration is symmetrical and the bridge is balanced. Consequently, there is no gas flow through bridging channel 136. On the other hand, when the measurement standoff 140 and reference standoff 142 are different, the resulting pressure difference between the measurement channel 116 and the reference channel 118 induces a flow of gas through mass flow sensor 138.

Mass flow sensor 138 is located along bridge channel 136, which can be at a central point. Mass flow sensor 138 senses gas flow induced by pressure differences between measurement channel 116 and reference channel 118. These pressure differences occur as a result of changes in the vertical positioning of measurement surface 132.

In an example where there is a symmetric bridge, the measurement standoff 140 and reference standoff 142 are equal. Mass flow sensor 138 will detect no mass flow because there will be no pressure difference between the measurement and reference channels 116 and 118. On the other hand, any differences between measurement standoff 140 and reference standoff 142 values can lead to different pressures in measurement channel 116 and reference channel 118. Proper offsets can be introduced for an asymmetric arrangement.

Mass flow sensor 138 senses gas flow induced by a pressure difference or imbalance. A pressure difference causes a gas flow, the rate of which is a unique function of the measurement standoff 140. In other words, assuming a constant flow rate into gas gauge 100, the difference between gas pressures in the measurement channel 116 and the reference channel 118 is a function of the difference between the magnitudes of standoffs 140 and 142. If reference standoff 142 is set to a known standoff, the difference between gas pressures in the measurement channel 116 and the reference channel 118 is a function of the size of measurement standoff 140 (that is, the unknown standoff in the z direction between measurement surface 132 and measurement probe 128).

Mass flow sensor 138 detects gas flow in either direction through bridge channel 136. Because of the bridge configuration, gas flow occurs through bridge channel 136 only when pressure differences between channels 116 and 118 occur. When a pressure imbalance exists, mass flow sensor 138 detects a resulting gas flow, and can initiate an appropriate control function, which can be done using optional controller 150 that is coupled to appropriate parts of system 100. Mass flow sensor 138 can provide an indication of a sensed flow through a visual display or audio indication, which can be done through use of optional output device 152.

Alternatively, in place of a mass flow sensor, a differential pressure sensor (not shown) can be used. The differential pressure sensor measures the difference in pressure between the two channels, which is a function of the difference between the measurement and reference standoffs.

The control function in optional controller 150 can be to calculate the exact gap differences. In another embodiment, the control function may be to increase or decrease the size of measurement standoff 140. This is accomplished by moving the measurement surface 132 relative to measurement probe 128 until the pressure difference is sufficiently close to zero, which occurs when there is no longer a difference between the standoffs from measurement surface 132 and reference surface 134.

It is to be appreciated that mass flow rate controller 106, snubber 110, and restrictors 120 and 122 can be used to reduce gas turbulence and other pneumatic noise, which can be used to allow the present invention to achieve nanometer accuracy. These elements may all be used within an embodiment of the present invention or in any combination depending on the sensitivity desired. For example, if an application required very precise sensitivity, all elements may be used. Alternatively, if an application required less sensitivity, perhaps only snubber 110 would be needed with porous restrictors 120 and 122 replaced by orifices. As a result, the present invention provides a flexible approach to cost effectively meet a particular application's requirements.

In one embodiment of the present invention porous restrictors 120 and 122 are used. Porous restrcitors 120 and 122 can be used instead of saphire restrictors when pressure needs to be stepped down in many steps, and not quickly. This can be used to avoid turbulence.

According to further embodiments of the present invention, the system 100 may be used within the systems disclosed in U.S. Ser. No. 10/322,768, filed Dec. 19, 2002, and U.S. Pat. Nos. 4,953,388 and 4,550,592, which are all incorporated by reference herein in their entireties, to significantly enhance their sensitivity.

Flow Restrictors

According to one embodiment of the present invention measurement channel 116 and reference channel 118 contain restrictors 120 and 122. Each restrictor 120 and 122 restricts the flow of gas traveling through their respective measurement channel 116 and reference channel 118. Measurement channel restrictor 120 is located within measurement channel 116 between junction 114 and junction 124. Likewise, reference channel restrictor 122 is located within reference channel 118 between junction 114 and junction 126. In one example, the distance from junction 114 to measurement channel restrictor 120 and the distance from junction 114 to reference channel restrictor 122 are equal. In other examples, the distances are not equal. There is no inherent requirement that the sensor be symmetrical, however, the sensor is easier to use if it is geometrically symmetrical.

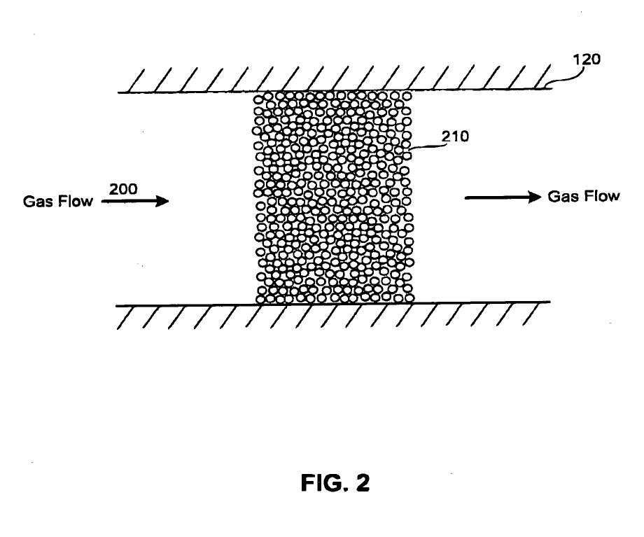

FIG. 2 provides a cross-sectional image of restrictor 120 having porous material 210 through which a gas flow 200 passes, according to a further feature of the present invention. Each restrictor 120 and 122 can consist of a porous material (e.g., polyethylene, sintered stainless steel, etc.). Measurement channel restrictor 120 and reference channel restrictor 122 can have substantially the same dimensions and permeability characteristics. In one example, restrictors 120 and 122 can range in length from about 2 to about 15 mm, but are not limited to these lengths. Measurement channel restrictor 120 and reference channel restrictor 122 can evenly restrict gas flow across the cross-sectional areas of the channels 116 and 118. Porous material restrictors can provide a significant reduction in turbulence and associated pneumatic noise. This is in comparison to the amount of turbulence and noise introduced by restrictors that use a single orifice bored out of a solid, non-porous material.

The restrictors can serve at least two key functions. First, they can mitigate the pressure and flow disturbances present in gas gauge proximity sensor 100, most notably disturbances generated by mass flow controller 110 or sources of acoustic pick-up. Second, they can serve as the required resistive elements within the bridge.

Exemplary embodiments of a gas gauge proximity sensor have been presented. The present invention is not limited to this example. This example is presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the present invention.

Nozzle

FIGS. 3-4 show a cross-sectional and end view of a nozzle 350, respectively, and characteristics thereof, according to embodiments of the present invention. The basic configuration of a gas gauge nozzle 350 is characterized by a flat end surface 351 that is parallel to measurement surface 132 or reference surface 134. The geometry of a nozzle is determined by the gauge standoff, h, and the inner diameter, d. Generally, the dependence of the nozzle pressure drop on the nozzle outer diameter D is weak, if D is sufficiently large. The remaining physical parameters are: Qₘ—mass flow rate of the gas, and Δp—pressure drop across the nozzle. The gas is characterized by the density, ρ, and dynamic viscosity, η.

A relationship is sought between non-dimensional parameters:

$$\frac{Δ p}{\frac{1}{2} ρ {u}^{2}} ,$$

the Reynolds Number, Re, and

$$\frac{h}{d} ,$$

where the radial velocity, u, is taken at the entrance to the cylindrical region between the nozzle face and the substrate surface. The Reynolds number is defined as

$$Re = \frac{ud}{v} ,$$

where ν is the kinematic coefficient of viscosity.

Therefore, the behavior of the nozzle can be described in terms of five physical variables: ν, Δp, Qₘ, d, and h. There is a relationship between Δp and h and the remaining variables would be typically constant for a practical system. This relationship facilitates the development of nozzle types for different applications, requiring different sensitivities.

As best seen in FIG. 4, nozzle 350 can be elongated along section 352 having height H and shorted along section 354 having a width W, as compared to nozzle 600. For example, in one embodiment a ratio of H to W can be about 2:1 to about 20:1, preferably about 10:1. It is to be appreciated that other ratios are also contemplated within the scope of the present invention. This can produce a long thin like orifice shape that is more efficient than a circular nozzle shape to perform topography measurements. Also, low sensitivity area 602 can be substantially eliminated because side restriction regions overlap, as seen by sensed area 358 and graph 360. Sensed area 358 can be a “scanned” footprint based on several successive readings. Graph 360 shows an area sensed along a diameter of nozzle 350. Thus, during a topography scan, a more uniform sensitivity footprint is produced. This yields a more accurate topographic measurement. This measurement can be simpler to compare with other sensor types, as described above. When used as a scanning device, nozzle 350 can cover a greater area of topography in a single scan because of its greater height profile.

For example, a nozzle having a diameter of 3 mm and an orifice of 1.1 mm should have a flange of about 0.95 mm. In the embodiment above, this nozzle can be stretched to form nozzle 350 having a diameter of 0.37 mm and an orifice of 2.5 mm, which should have a flange of 0.25 mm.

As another example, a width W of the nozzle 350 can be reduced by a factor of about 10% compared to nozzle 600, a height H can be increased by a factor of about 250%*PI(π), while maintaining a same surface area. With only 10% of the width compared to circular nozzles, the dead area is greatly minimized as the side restriction regions (which are not labeled because they are no long distinguishable based on orifice configuration) overlap, as is best seen comparing curve 358 in FIG. 4 and curve 602 in FIG. 6. With the height H increase of roughly 800%, when used as a scanning device, nozzle 350 can cover a greater area of topography in a single scan. All topography scanned would convolute with a more uniform sensitivity footprint. The nozzle could also be applied to vacuum based proximity sensing.

Exemplary embodiments of a nozzle has been presented. The present invention is not limited to this example. The example is presented herein for purposes of illustration, and not limitation. Alternatives (including equivalents, extensions, variations, deviations, etc., of those described herein) will become apparent to persons skilled in the relevant art(s) based on the teachings contained herein. Such alternatives fall within the scope and spirit of the present invention.

Methods

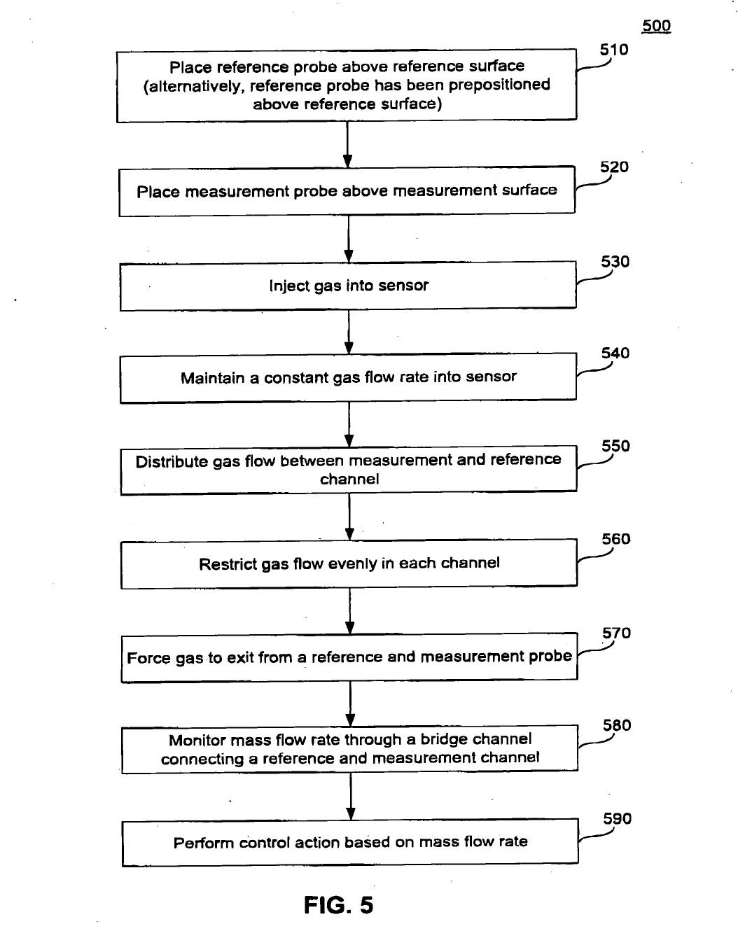

FIG. 5 illustrates a flow-chart depicting a method 500 for using gas flow to detect very small distances and perform a control action (e.g., steps 510-570). For convenience, method 500 is described with respect to gas gauge proximity sensor 100. However, method 500 is not necessarily limited by the structure of sensor 100, and can be implemented with gas gauge proximity sensor with a different structure.

In step 510, a reference probe is positioned above a reference surface (e.g., by an operator, a mechanical device, a robotic arm, or the like). For example, a robot can position reference probe 130 above reference surface 134 with known reference standoff 142. Alternatively, the reference standoff can be arranged within the sensor assembly, that is, internal to the sensor assembly. The reference standoff is pre-adjusted to a particular value, which typically is maintained constant.

In step 520, a measurement probe is positioned above a measurement surface. For example, measurement probe 128 is positioned above measurement surface 132 to form measurement gap 140.

In step 530, gas is injected into a sensor. For example, a measurement gas is injected into gas gauge proximity sensor 100 with a constant mass flow rate. In step 540, a constant gas flow rate into a sensor is maintained. For example, mass flow controller 106 maintains a constant gas flow rate. In step 550, gas flow is distributed between measurement and reference channels. For example, gas gauge proximity sensor 100 causes the flow of the measurement gas to be evenly distributed between measurement channel 116 and reference channel 118.

In step 560, gas flow in the measurement channel and the reference channel is restricted evenly across cross-sectional areas of the channels. Measurement channel restrictor 120 and reference channel restrictor 122 restrict the flow of gas to reduce pneumatic noise and serve as a resistive element in gas gauge proximity sensor 100.

In step 570, gas is forced to exit from a reference and measurement probe. For example, gas gauge proximity sensor 100 forces gas to exit measurement probe 128 and reference probe 130. In step 580, a flow of gas is monitored through a bridge channel connecting a reference channel and a measurement channel. In step 590, a control action is performed based on a pressure difference between the reference and measurement channel. For example, mass flow sensor 138 monitors mass flow rate between measurement channel 116 and reference channel 118. Based on the mass flow rate, mass flow sensor 138 initiates a control action. Such control action can include providing an indication of the sensed mass flow, sending a message indicating a sensed mass flow, or initiating a servo control action to reposition the location of the measurement surface relative to the reference surface until no mass flow or a fixed reference value of mass flow is sensed. It is to be appreciated that these control actions are provided by way of example, and not limitation.

Additional steps or enhancements to the above steps known to persons skilled in the relevant art(s) form the teachings herein are also encompassed by the present invention.

The present invention has been described with respect to FIGS. 1-5 with reference to a gas. In one embodiment the gas is air. The present invention is not limited to air. Other gases or combinations of gases can be used. For example, depending on the surface being measured, a gas having a reduced moisture content or an inert gas may be used. A low moisture content gas or inert gas is less likely than air to react with the surface being measured.

### CONCLUSION

While various embodiments of the present invention have been described above, it should be understood that they have been presented by way of example, and not limitation. It will be apparent to persons skilled in the relevant art that various changes in form and detail can be made therein without departing from the spirit and scope of the invention.

The present invention has been described above with the aid of method steps illustrating the performance of specified functions and relationships thereof. The boundaries of these method steps have been arbitrarily defined herein for the convenience of the description. Alternate boundaries can be defined so long as the specified functions and relationships thereof are appropriately performed. Any such alternate boundaries are thus within the scope and spirit of the claimed invention. Thus, the breadth and scope of the present invention should not be limited by any of the above-described exemplary embodiments, but should be defined only in accordance with the following claims and their equivalents.

1. A system comprising:
means for directing a gas stream into a reference channel and a measurement channel;
means for evenly restricting gas flow through the reference channel and the measurement channel;
probes located adjacent ends of the reference channel and the measurement channel and having an elongated nozzle orifice; and
means for sensing a mass of gas flow between the reference channel and the measurement channel.

2. The system of claim 1, further comprising:
a reference surface positioned a reference standoff from the reference probe, a gas stream from the reference probe impinges on the reference surface after traveling across the reference standoff; and
a measurement surface positioned a measurement standoff from the measurement probe, a gas stream from the measurement probe impinges on the measurement surface after traveling across the measurement standoff,
wherein the means for sensing senses a difference between the reference standoff and the measurement standoff.

3. The system of claim 1, further comprising:
means for controlling a mass flow rate of the gas stream positioned before the means for directing.

4. The system of claim 3, further comprising:
means for reducing gas turbulence positioned after the means for controlling.

5. The system of claim 1, wherein the nozzle orifice has a height H which is larger than a width W.

6. The system of claim 1, wherein:
the nozzle orifice has a height H and a width W; and
a ratio of H to W is about 2:1 to about 20:1.

7. The system of claim 1, wherein:
the nozzle orifice has a height H and a width W; and
a ratio of H to W is about 10:1.

8. A gas gauge proximity sensor that is provided with a gas supply during operation, comprising:
a dividing portion that divides the supplied gas into a reference channel and a measurement channel;
flow restrictors placed in the reference channel and measurement channel;
probes respectively coupled adjacent ends of the reference channel and the measurement channel, the probes including elongated nozzle orifices; and
a mass flow sensor coupled between the reference and measurement channels that senses the mass of gas flow therebetween.

9. The gas gauge proximity sensor of claim 8, further comprising:
a reference surface positioned a reference standoff from the reference probe, a gas stream from the reference probe impinges on the reference surface after traveling across the reference standoff; and
a measurement surface positioned a measurement standoff from the measurement probe, a gas stream from the measurement probe impinges on the measurement surface after traveling across the measurement standoff,
wherein the mass flow sensor senses a difference between the reference standoff and the measurement standoff.

10. The system of claim 8, further comprising:
a mass flow rate controller positioned before the dividing portion.

11. The system of claim 10, further comprising:
a snubber located after the mass flow controller to reduce gas turbulence.

12. The system of claim 8, wherein the nozzle orifice has a height H which is larger than a width W.

13. The system of claim 8, wherein:
the nozzle orifice has a height H and a width W; and
a ratio of H to W is about 2:1 to about 20:1.

14. The system of claim 8, wherein:
the nozzle orifice has a height H and a width W; and
a ratio of H to W is about 10:1.

15. A method for proximity sensing comprising:
directing a gas stream into a reference channel and a measurement channel;
restricting gas flow through the reference channel and the measurement channel;
positioning nozzles having elongated orifices in probes adjacent ends of the reference channel and the measurement channel and proximate to a reference surface and a measurement surface; and
sensing a mass of gas flow between the reference channel and the measurement channel, to thereby determine measuring measurement channel and reference channel standoffs.

16. The method of claim 15, wherein the restricting gas flow step comprises evenly restricting the gas flow.

17. The method of claim 15, further comprising forming the elongated orifice with a height about two to about twenty times a width.

18. The method of claim 15, further comprising forming the elongated orifice with a height about ten times a width.
